(19) United States
(12) Patent Application Publication
(10) Pub. No.: US 2026/0367359 A1
(43) Pub. Date: Nov. 19, 2026

(54) Camera Optical Lens

(71) Applicant: Changzhou AAC Raytech Optronics Co., Ltd., Changzhou City (CN)

(72) Inventor: Chen Chen, Changzhou (CN)

(21) Appl. No.: 19/292,969

(22) Filed: Aug. 7, 2025

Related U.S. Application Data
(63) Continuation of application No. PCT/CN2024/142576, filed on Dec. 26, 2024.

(51) Int. Cl. G02B 13/00; G02B 9/34

(52) U.S. Cl. CPC G02B 13/004; G02B 9/34

(57) ABSTRACT

The present disclosure relates to optical lens and discloses a camera optical lens including four lenses which are, in an order from an object side to an image side in sequence: a first lens with a negative refractive power, a second lens with a positive refractive power, a third lens with a positive refractive power, a fourth lens with a positive refractive power. The camera optical lens further satisfies the following conditions: −1.40≤f1/f≤−1.15; 35.00≤FOV/Fno≤70.00; 2.00≤ET1/d1≤2.90; 1.70≤f3/f4≤3.20; 0.60≤(R3+R4)/f2≤2.40. The camera optical lens provided by the present disclosure has a wide field of view, large depth of field, and high-definition imaging capabilities.

### CROSS-REFERENCE TO RELATED APPLICATIONS

This application claims the priority benefit of PCT Patent Application Ser. No. PCT/CN2024/142576 filed on Dec. 26, 2024, the entire content of which is incorporated herein by reference.

### FIELD OF THE PRESENT DISCLOSURE

The present disclosure relates to optical lens, in particular to a camera optical lens suitable for medical imaging equipment.

### DESCRIPTION OF RELATED ART

In recent years, with the rapid development of medical equipment, the demand for miniaturized endoscopic camera optical lenses has been increasing. However, the form quality of conventional camera optical lenses is relatively poor, unable to meet the requirements of medical imaging equipment.

In related technologies, camera optical lenses mostly adopt three-piece, four-piece, or even five-piece lens configurations, among which four-piece structures dominate. Nevertheless, how to reasonably design the focal lengths, thicknesses, and surface profiles of lenses under the premise of maintaining identical four-piece dimensions, thereby enhancing their field of view, depth of field, and imaging quality, has become the most challenging issue today.

Therefore, there is an urgent need for a camera optical lens to address the aforementioned problems.

### SUMMARY

To address the above issues, it is an object of the present disclosure to provide a camera optical lens designed to achieve a wide field of view, a large depth of field, and high-definition imaging.

In order to overcome shortcomings in the prior art, the present disclosure provides a camera optical lens including four lenses which are, in an order from an object side to an image side in sequence: a first lens with a negative refractive power, a second lens with a positive refractive power, a third lens with a positive refractive power, a fourth lens with a positive refractive power; wherein the camera optical lens further satisfies the following conditions:

−1.40≤f1/f≤−1.15;

35.00≤FOV/Fno≤66.00;

2.00≤ET1/d1≤2.90;

1.70≤f3/f4≤3.20;

0.60≤(R3+R4)/f2≤2.40; where
f: the focal length of the camera optical lens;
f1: the focal length of the first lens;
f2: the focal length of the second lens;
f3: the focal length of the third lens;
f4: the focal length of the fourth lens;
FOV: the field angle of field 1.0 of the camera optical lens;
Fno: the f-number of the camera optical lens;
ET1: the edge thickness of the optical clear aperture of the first lens;
d1: the thickness on-axis of the first lens;
R3: the central curvature radius of the object side surface of the second lens;
R4: the central curvature radius of the image side surface of the second lens.

As an improvement, the camera optical lens further satisfies the following condition:

5.50≤TTL/f≤7.00; where
TTL: the total optical length of the camera optical lens.

As an improvement, at least one of the first lens, the second lens, the third lens, and the fourth lens is made of glass material.

As an improvement, the camera optical lens further satisfies the following condition:

Dmax≤2.00%; where
Dmax: the maximum absolute value of distortion within the 0.7 field of the camera optical lens.

As an improvement, an image side surface of the first lens is concave in the paraxial region, the camera optical lens further satisfies the following conditions:

0.57≤(R1+R2)/(R1−R2)≤1.30;

0.08≤d1/TTL≤0.15; where
TTL: the total optical length of the camera optical lens;
R1: the central curvature radius of object side surface of the first lens;
R2: the central curvature radius of image side surface of the first lens.

As an improvement, an object side surface of the second lens is convex in the paraxial region, an image side surface of the second lens is concave in the paraxial region, the camera optical lens further satisfies the following conditions:

2.09≤f2/f≤3.99;

−7.23≤(R3+R4)/(R3−R4)≤−1.89;

0.14≤d3/TTL≤0.3; where
TTL: the total optical length of the camera optical lens;
d3: the thickness on-axis of the second lens.

As an improvement, an image side surface of the third lens is convex in the paraxial region, the camera optical lens further satisfies the following conditions:

3.56≤f3/f≤5.39;

−0.18≤(R5+R6)/(R5−R6)≤1.04;

0.07≤d5/TTL≤0.15; where
TTL: the total optical length of the camera optical lens;
R5: the central curvature radius of object side surface of the third lens;
R6: the central curvature radius of image side surface of the third lens;
d5: the thickness on-axis of the third lens.

As an improvement, an object side surface of the fourth lens is convex in the paraxial region, an image side surface of the fourth lens is convex in the paraxial region, the camera optical lens further satisfies the following conditions:

1.62≤f4/f≤2.02;

−0.16≤(R7+R8)/(R7−R8)≤0.71;

0.10≤d7/TTL≤0.23; where
TTL: the total optical length of the camera optical lens;
R7: the central curvature radius of object side surface of the fourth lens;
R8: the central curvature radius of image side surface of the fourth lens;
d7: the thickness on-axis of the fourth lens.

As an improvement, the camera optical lens further satisfies the following condition: 2.19≤Fno≤3.37.

As an improvement, the camera optical lens further satisfies the following condition:

0.38≤TTL≤4.16; where
TTL: the total optical length of the camera optical lens.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a schematic diagram of a camera optical lens in accordance with a first embodiment of the present disclosure;

FIG. 2 shows the longitudinal aberration of the camera optical lens shown in FIG. 1;

FIG. 3 shows the lateral color of the camera optical lens shown in FIG. 1;

FIG. 4 presents a schematic diagram of the field curvature and distortion of the camera optical lens shown in FIG. 1;

FIG. 5 is a schematic diagram of a camera optical lens in accordance with a second embodiment of the present disclosure;

FIG. 6 presents the longitudinal aberration of the camera optical lens shown in FIG. 5;

FIG. 7 presents the lateral color of the camera optical lens shown in FIG. 5;

FIG. 8 presents the field curvature and distortion of the camera optical lens shown in FIG. 5;

FIG. 9 is a schematic diagram of a camera optical lens in accordance with a third embodiment of the present disclosure;

FIG. 10 presents the longitudinal aberration of the camera optical lens shown in FIG. 9;

FIG. 11 presents the lateral color of the camera optical lens shown in FIG. 9;

FIG. 12 presents the field curvature and distortion of the camera optical lens shown in FIG. 9.

FIG. 13 is a schematic diagram of a camera optical lens in accordance with a fourth embodiment of the present disclosure;

FIG. 14 presents the longitudinal aberration of the camera optical lens shown in FIG. 13;

FIG. 15 presents the lateral color of the camera optical lens shown in FIG. 13;

FIG. 16 presents the field curvature and distortion of the camera optical lens shown in FIG. 13.

FIG. 17 is a schematic diagram of a camera optical lens in accordance with a fifth embodiment of the present disclosure;

FIG. 18 presents the longitudinal aberration of the camera optical lens shown in FIG. 17;

FIG. 19 presents the lateral color of the camera optical lens shown in FIG. 17;

FIG. 20 presents the field curvature and distortion of the camera optical lens shown in FIG. 17.

FIG. 21 is a schematic diagram of a camera optical lens in accordance with a sixth embodiment of the present disclosure;

FIG. 22 presents the longitudinal aberration of the camera optical lens shown in FIG. 21;

FIG. 23 presents the lateral color of the camera optical lens shown in FIG. 21;

FIG. 24 presents the field curvature and distortion of the camera optical lens shown in FIG. 21.

FIG. 25 is a schematic diagram of a camera optical lens in accordance with a seventh embodiment of the present disclosure;

FIG. 26 presents the longitudinal aberration of the camera optical lens shown in FIG. 25;

FIG. 27 presents the lateral color of the camera optical lens shown in FIG. 25;

FIG. 28 presents the field curvature and distortion of the camera optical lens shown in FIG. 25.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

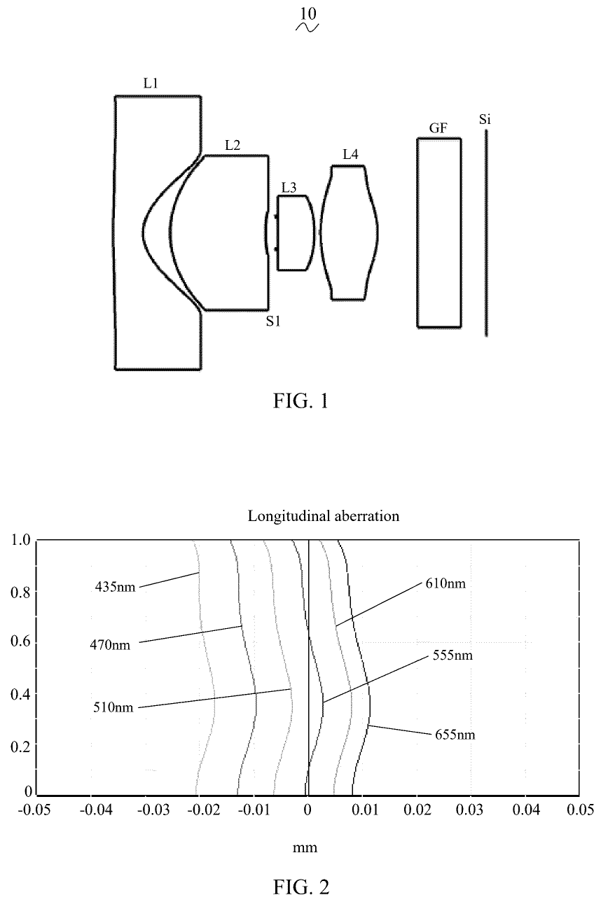

With reference to the accompanying drawings, the present disclosure provides camera optical lenses 10, 20, 30, 40, 50, 60, and 70. As shown in FIGS. 1, 5, 9, 13, 17, 21, and 25, the camera optical lenses 10, 20, 30, 40, 50, 60, and 70 each includes four lenses. Specifically, in an order from the object side to the image side, the camera optical lenses each sequentially includes a first lens L1 with a negative refractive power, a second lens L2 with a positive refractive power, an aperture stop S1, a third lens L3 with a positive refractive power, and a fourth lens L4 with a positive refractive power. Optical element like optical filter GF can be arranged between the fourth lens L4 and the image plane Si.

Here, the focal length of the camera optical lenses 10, 20, 30, 40, 50, 60, and 70 is defined as f, and the focal length of the first lens is defined as f1. The following condition is satisfied: −1.40≤f1/f≤−1.15. This defines the ratio of the focal length of the first lens L1 to the focal length of the camera optical lenses 10, 20, 30, 40, 50, 60, and 70. By rationally distributing the optical power of the camera optical lenses 10, 20, 30, 40, 50, 60, and 70, it achieves superior imaging quality and reduced sensitivity.

The field of view angle at the 1.0 field of the camera optical lenses 10, 20, 30, 40, 50, 60, and 70 is defined as FOV, and the f-number of the camera optical lenses 10, 20, 30, 40, 50, 60, and 70 is defined as Fno. The following conditional is satisfied: 35.00≤FOV/Fno≤66.00.

The edge thickness of the optical clear aperture of the first lens L1 is defined as ET1, and the thickness on-axis of the first lens L1 is defined as d1. The following conditional expression is satisfied: 2.00≤d1ET1≤2.90. This defines the ratio of the edge thickness to the optical clear aperture of the first lens L1, which facilitates lens processing and lens assembly.

The focal length of the third lens L3 is defined as f3, and the focal length of the fourth lens L4 is defined as f4. The following conditional expression is satisfied: 1.70≤f3/f4≤3.20. This defines the ratio of the focal length of the third lens L3 to that of the fourth lens L4. By rationally distributing the optical power of the camera optical lenses 10, 20, 30, 40, 50, 60, and 70, it facilitates smoother light transition and enhances imaging quality.

The focal length of the second lens L2 is defined as f2, the central curvature radius of the object side surface of the second lens L2 is defined as R3, and the central curvature radius of the image side surface of the second lens L2 is defined as R4. The following conditional expression is satisfied: 0.60≤(R3+R4)/f2≤2.40. This rationally constrains the surface profile of the second lens L2, which reduces the sensitivity of the camera optical lenses 10, 20, 30, 40, 50, 60, and 70, suppresses stray light, and enhances imaging quality.

When the above conditional expressions are satisfied, the camera optical lenses 10, 20, 30, 40, 50, 60, and 70 exhibit excellent optical performance while simultaneously meeting the design requirements for a wide field of view, large depth of field, and high-definition imaging. Based on these characteristics, the camera optical lenses 10, 20, 30, 40, 50, 60, and 70 are particularly suitable for mobile phone camera modules, web camera lenses, and medical imaging equipment incorporating high-pixel CCD, CMOS, and other imaging sensors.

The total optical length of the camera optical lenses 10, 20, 30, 40, 50, 60, and 70 is defined as TTL. The following conditional expression is satisfied: 5.50≤TTL/f≤7.00. This specifies the telephoto ratio. By constraining the upper limit of the conditional expression, the optical total track length is controlled to be shortened, facilitating miniaturization. On the other hand, by exceeding the lower limit, it facilitates the correction of distortion and on-axis chromatic aberration, thereby maintaining excellent optical performance.

The first lens L1, the second lens L2, and the third lens L3 are made of plastic material, while the fourth lens L4 is made of glass material. This material allocation effectively leverages the properties of both materials to correct chromatic aberration, ensuring that the chromatic aberration |LC|≤7.0 μm. Although other materials may be used for the lenses, at least one lens is made of glass material.

The maximum absolute value of distortion within the 0.7 field of the camera optical lens is defined as Dmax. The following conditional expression is satisfied: Dmax≤2.00%.

Based on the aforementioned conditional expressions and achievable functions, the characteristics of each lens are further refined as follow.

The object side surface of the first lens L1 is convex or concave in the paraxial region, while the image side surface is concave in the paraxial region. The object side and image side surfaces of the first lens L1 may alternatively be configured with other concave/convex distributions.

The central curvature radius of object side surface of the first lens L1 is defined as R1, and the central curvature radius of the image side surface of the first lens L1 is defined as R2. The following conditional expression is satisfied: 0.57≤(R1+R2)/(R1−R2)≤1. This rationally constraining the shape of the first lens L1, the first lens L1 can effectively correct spherical aberration in the optical system.

The thickness on-axis of the first lens L1 is defined as d1. The following conditional expression is satisfied: 0.08≤d1/TTL≤0. Within this range, the conditional expression facilitates an ultra-thin design.

The object side surface of the second lens L2 is convex in the paraxial region, and the image side surface of the second lens L2 is concave in the paraxial region. The object side and image side surfaces of the second lens L2 may alternatively be configured with other concave/convex distributions.

The following conditional expression is satisfied: 2.09≤f2/f≤3.99. By constraining the positive refractive power of the second lens L2 within this rational range, aberrations of the optical system can be effectively corrected.

The following conditional expression is satisfied: −7.23≤(R3+R4)/(R3−R4)≤−1.89. This constrains the shape of the second lens L2. Within this range, as the lens evolves toward an ultra-thin and wide-angle configuration, it facilitates the compensation of axial chromatic aberration.

The thickness on-axis of the second lens L2 is defined as d3. The following conditional expression is satisfied: 0.14≤d3/TTL≤0.3. Within this range, the conditional expression facilitates an ultra-thin design.

The object side surface of the third lens L3 is concave or convex in the paraxial region, and the image side surface is convex in the paraxial region. The object side and image side surfaces of the third lens L3 may alternatively be configured with other convex/concave distributions.

The following conditional expression is satisfied: 3.56≤f3/f≤5.39. By rationally allocating the refractive power, the optical system achieves enhanced imaging quality and reduced aberration sensitivity.

The central curvature radius of object side surface of the third lens L3 is defined as R5, and the central curvature radius of image side surface of the third lens L3 is defined as R6. The following conditional expression is satisfied: −0.18≤(R5+R6)/(R5−R6)≤1.04. This constrains the shape of the third lens L3, facilitates its manufacturing, and moderates the deflection angle of light rays passing through the lens within the specified range, thereby effectively reducing aberrations.

The thickness on-axis of the third lens L3 is defined as d5. The following conditional expression is satisfied: 0.07≤d5/TTL≤0.15. Within this range, the conditional expression facilitates an ultra-thin design.

The object side surface of the fourth lens L4 is convex in the paraxial region, and the image side surface of the fourth lens L4 is convex in the paraxial region. The object side and image side surfaces of the fourth lens L4 may alternatively be configured with other convex/concave distributions.

The following conditional expression is satisfied: 1.62≤f4/f≤2.02. By rationally allocating the refractive power, the optical system achieves enhanced imaging quality and reduced aberration sensitivity.

The central curvature radius of object side surface of the fourth lens L4 is defined as R7, and the central curvature radius of image side surface of the fourth lens L4 is defined as R8. The following conditional expression is satisfied: −0.16≤(R7+R8)/(R7−R8)≤0.71. This constrains the shape of the fourth lens L4. Within this range, as the lens evolves toward an ultra-thin and wide-angle configuration, it facilitates the correction of aberrations at off-axis field angles.

The thickness on-axis of the fourth lens L4 is defined as d7. The following conditional expression is satisfied: 0.10≤d7/TTL≤0.23. Within this range, the conditional expression facilitates an ultra-thin design.

The camera optical lenses 10, 20, 30, 40, 50, 60, and 70 satisfy the following conditional expression: 2.19≤Fno≤3.37, thereby achieving a large aperture and superior imaging performance.

The camera optical lenses 10, 20, 30, 40, 50, 60, and 70 satisfy the following conditional expression: 0.38≤TTL≤4.16.

The camera optical lenses 10, 20, 30, 40, 50, 60, and 70 achieve technical effects of wide field of view, large depth of field, and high-definition imaging. Based on the characteristics of the camera optical lenses 10, 20, 30, 40, 50, 60, and 70, the camera optical lenses 10, 20, 30, 40, 50, 60, and 70 are particularly suitable for medical imaging equipment.

The camera optical lenses 10, 20, 30, 40, 50, 60, and 70 of the present disclosure will be described below with reference to various embodiments. The symbols used in each embodiment are as follows. The focal length, the distance on-axis, the central curvature radius, and the thickness on-axis are expressed in millimeters.

TTL: Total optical length (the distance on-axis from the object side surface of the first lens L1 to the image plane), expressed in millimeters.

Fno: f-number, defined as the ratio of the effective focal length to the entrance pupil diameter of the camera optical lenses 10, 20, 30, 40, 50, 60, and 70.

IH: Image height at the 1.0 field, corresponding to the diagonal half-length of the effective pixel area of the image sensor.

FOV: Field of view angle at the 1.0 field, corresponding to the angular coverage of the effective pixel area of the image sensor.

The technical solutions of the present disclosure will be specifically described through seven embodiments. It is noted that the technical effects of the disclosure cannot be achieved if the parameters exceed the ranges defined in the aforementioned conditional expressions.

### Embodiment 1

The object side surface of the first lens L1 is convex in the paraxial region, and the object side surface of the third lens L3 is concave in the paraxial region.

Tables 1 and 2 present the design data of the camera optical lens 10 according to the first embodiment of the present disclosure.

TABLE 1

| | R | d | | nd | | vd | |
|---|---|---|---|---|---|---|---|
| S1 | ∞ | d0= | −1.699 | | | | |
| R1 | 2.816 | d1= | 0.314 | nd1 | 1.5444 | v1 | 55.82 |
| R2 | 0.360 | d2= | 0.284 | | | | |
| R3 | 0.914 | d3= | 0.996 | nd2 | 1.6700 | v2 | 19.39 |
| R4 | 1.623 | d4= | 0.125 | | | | |
| R5 | −78.697 | d5= | 0.383 | nd3 | 1.5444 | v3 | 55.82 |
| R6 | −1.438 | d6= | 0.065 | | | | |
| R7 | 1.038 | d7= | 0.597 | nd4 | 1.4959 | v4 | 81.64 |
| R8 | −0.784 | d8= | 0.416 | | | | |
| R9 | ∞ | d9= | 0.452 | ndg | 1.5168 | vg | 64.17 |
| R10 | ∞ | d10= | 0.267 | | | | |

Where:
In which, the meaning of the various symbols is as follows.
S1: Aperture;
R: The curvature radius of the optical surface, the central curvature radius in case of lens;
R1: The central curvature radius of the object side surface of the first lens L1;
R2: The central curvature radius of the image side surface of the first lens L1;
R3: The central curvature radius of the object side surface of the second lens L2;
R4: The central curvature radius of the image side surface of the second lens L2;
R5: The central curvature radius of the object side surface of the third lens L3;
R6: The central curvature radius of the image side surface of the third lens L3;
R7: The central curvature radius of the object side surface of the fourth lens L4;
R8: The central curvature radius of the image side surface of the fourth lens L4;
R9: The central curvature radius of the object side surface of the optical filter GF;
R10: The central curvature radius of the image side surface of the optical filter GF;
d: The thickness on-axis of the lens and the distance on-axis between the lens;
d0: The distance on-axis from aperture S1 to the object side surface of the first lens L1;
d1: The thickness on-axis of the first lens L1;
d2: The distance on-axis from the image side surface of the first lens L1 to the object side surface of the second lens L2;
d3: The thickness on-axis of the second lens L2;
d4: The distance on-axis from the image side surface of the second lens L2 to the object side surface of the third lens L3;
d5: The thickness on-axis of the third lens L3;
d6: The distance on-axis from the image side surface of the third lens L3 to the object side surface of the fourth lens L4;
d7: The thickness on-axis of the fourth lens L4;
d8: The distance on-axis from the image side surface of the fourth lens L4 to the object side surface of the optical filter GF;
d9: The thickness on-axis of the optical filter GF;
d10: The distance on-axis from the image side surface of the optical filter GF to the image plane Si;
nd: The refractive power of the d line (the D-line corresponds to green light with a wavelength of 550 nm);
nd1: The refractive power of the d line of the first lens L1;
nd2: The refractive power of the d line of the second lens L2;
nd3: The refractive power of the d line of the third lens L3;
nd4: The refractive power of the d line of the fourth lens L4;
ndg: The refractive power of the d line of the optical filter GF;
vd: The abbe number;
v1: The abbe number of the first lens L1;
v2: The abbe number of the second lens L2;
v3: The abbe number of the third lens L3;
v4: The abbe number of the fourth lens L4;
vg: The abbe number of the optical filter GF.

Table 2 shows the aspherical surface data of the camera optical lens 10 in the embodiment 1 of the present disclosure.

TABLE 2

| | Conic Index | Aspherical Surface Index | | | | |
|---|---|---|---|---|---|---|
| | k | A4 | A6 | A8 | A10 | A12 |
| R1 | −4.0266E−04 | −1.1458E+00 | 4.8591E+00 | −1.4153E+01 | 2.9672E+01 | −4.5443E+01 |
| R2 | −1.0007E+00 | −1.5463E+00 | −8.3659E+00 | 2.8177E+02 | −3.2121E+03 | 2.2032E+04 |
| R3 | 1.6103E−02 | −1.5972E−01 | 1.0965E+00 | −4.5385E+01 | 7.6350E+02 | −8.0264E+03 |
| R4 | −1.7677E+00 | 3.4912E+00 | −2.4531E+02 | 2.7644E+04 | −1.9538E+06 | 9.4934E+07 |
| R5 | −7.5000E+01 | 1.1477E+00 | −4.4500E+01 | 8.1821E+03 | −1.0352E+06 | 9.0199E+07 |
| R6 | 3.5382E−01 | −3.3137E+00 | 1.8680E+01 | 1.0948E+03 | −4.2629E+04 | 6.9410E+05 |
| R7 | 6.7581E−02 | −3.3273E+00 | 4.8504E+01 | −4.9731E+02 | 3.4964E+03 | −1.6814E+04 |
| R8 | −3.4734E−03 | 7.1032E−01 | 2.0624E+00 | −4.2887E−02 | 6.3578E+00 | −6.9904E+01 |
| | Conic Index | Aspherical Surface Index | | | | |
| | k | A14 | A16 | A18 | A20 | A22 |
| R1 | −4.0266E−04 | 5.0831E+01 | −4.1234E+01 | 2.3904E+01 | −9.6312E+00 | 2.5589E+00 |
| R2 | −1.0007E+00 | −9.8764E+04 | 2.9284E+05 | −5.6361E+05 | 6.5309E+05 | −3.2441E+05 |
| R3 | 1.6103E−02 | 5.9145E+04 | −3.1564E+05 | 1.2180E+06 | −3.3639E+06 | 6.5518E+06 |
| R4 | −1.7677E+00 | −3.2215E+09 | 7.6354E+10 | −1.2375E+12 | 1.3051E+13 | −8.0534E+13 |
| R5 | −7.5000E+01 | −5.0146E+09 | 1.7353E+11 | −3.6049E+12 | 4.1043E+13 | −1.9660E+14 |
| R6 | 3.5382E−01 | −5.1110E+06 | −4.3934E+06 | 4.0244E+08 | −3.2846E+09 | 1.1884E+10 |
| R7 | 6.7581E−02 | 5.3879E+04 | −1.0971E+05 | 1.2824E+05 | −6.5441E+04 | 0.0000E+00 |
| R8 | −3.4734E−03 | 5.6495E+01 | 3.4834E+02 | −7.7747E+02 | 4.8897E+02 | 0.0000E+00 |

| | |
|---|---|
| Conic Index | Aspherical Surface Index |

| | k | A24 | A26 | A28 | A30 |
|---|---|---|---|---|---|
| R1 | −4.0266E−04 | −4.0280E−01 | 2.8442E−02 | 0.0000E+00 | 0.0000E+00 |
| R2 | −1.0007E+00 | −1.9422E+05 | 4.0596E+05 | −2.4459E+05 | 5.4647E+04 |
| R3 | 1.6103E−02 | −8.7692E+06 | 7.6703E+06 | −3.9471E+06 | 9.0602E+05 |
| R4 | −1.7677E+00 | 2.2037E+14 | 0.0000E+00 | 0.0000E+00 | 0.0000E+00 |
| R5 | −7.5000E+01 | 0.0000E+00 | 0.0000E+00 | 0.0000E+00 | 0.0000E+00 |
| R6 | 3.5382E−01 | −1.6902E+10 | 0.0000E+00 | 0.0000E+00 | 0.0000E+00 |
| R7 | 6.7581E−02 | 0.0000E+00 | 0.0000E+00 | 0.0000E+00 | 0.0000E+00 |
| R8 | −3.4734E−03 | 0.0000E+00 | 0.0000E+00 | 0.0000E+00 | 0.0000E+00 |

For convenience, the aspheric surface of each lens surface uses the aspheric surfaces shown in the following condition (1). However, the present disclosure is not limited to the aspherical polynomials form shown in the condition (1).

z=(cr2)/{1+[1−(k+1)(c2r2)]1/2}+A4r4+A6r6+A8r8+A10r10+A12r12+A14r14+A16r1 6+A18r18+A20r20+A22r22+A24r24+A26r26+A28r28+A30r30 (1)

Among them, K is a conic index, A4, A6, A8, A10, A12, A14, A16, A18, A20, A22, A24, A26, A28, A30 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

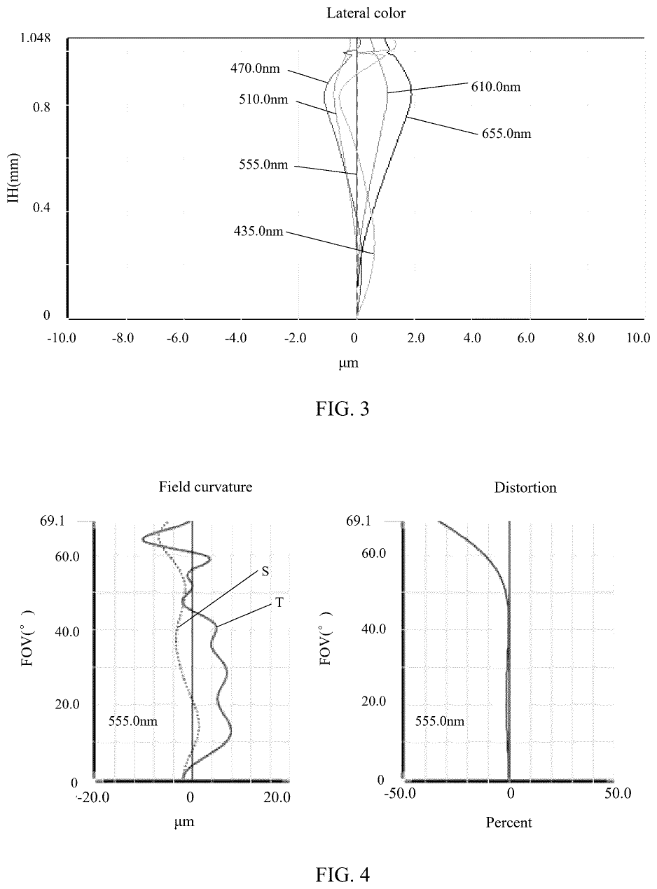

FIG. 2 and FIG. 3 show the longitudinal aberration and lateral color schematic diagrams after light with a wavelength of 655 nm, 610 nm, 555 nm, 510 nm, 470 nm and 435 nm passes the camera optical lens 10 in the first embodiment. FIG. 4 shows the field curvature and distortion schematic diagrams after light with a wavelength of 555 nm passes the camera optical lens 10 in the first embodiment, the field curvature S in FIG. 4 is a field curvature in the sagittal direction, T is a field curvature in the meridian direction.

In this embodiment, the pupil entering diameter of the camera optical lens is 0.197 mm, the image height at the 1.0 field position is 1.048 mm, the vision field angle at the 1.0 field position is 139.66°, and the f-number is 3.03. The camera optical lens 10 satisfies the design requirements of a wide field of view, large depth of field, and high-definition imaging.

### Embodiment 2

Embodiment 2 is basically the same as embodiment 1, the meaning of its symbols is the same as that of embodiment 1, in the following, only the differences are described.

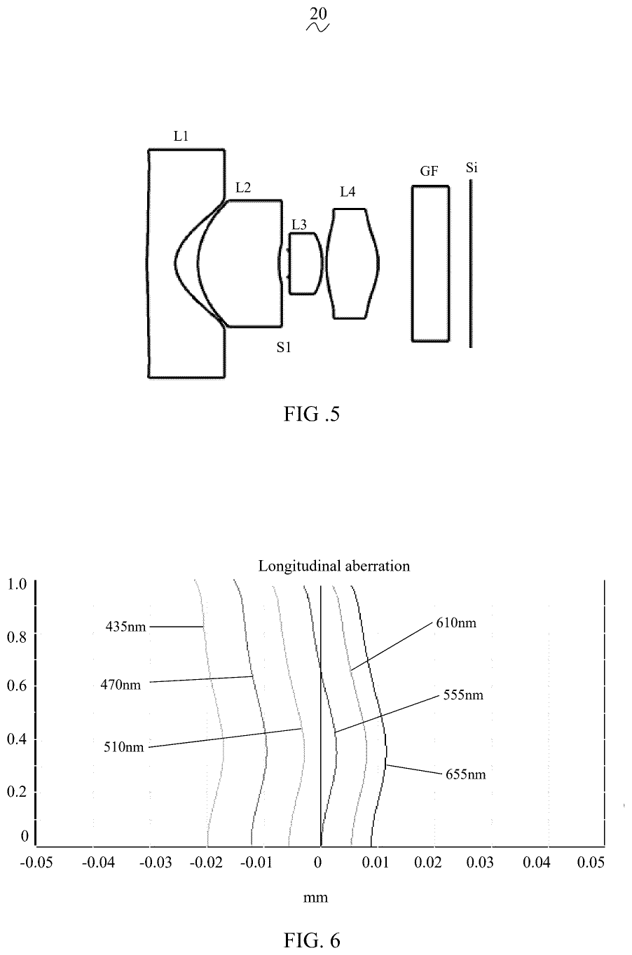

FIG. 5 illustrates a camera optical lens 20 according to a second embodiment of the present disclosure.

Tables 3 and 4 present the design data of the camera optical lens 20 according to the second embodiment of the present disclosure.

TABLE 3

| | R | d | | nd | | vd | |
|---|---|---|---|---|---|---|---|
| S1 | ∞ | d0= | −1.711 | | | | |
| R1 | 2.842 | d1= | 0.346 | nd1 | 1.5444 | v1 | 55.82 |
| R2 | 0.359 | d2= | 0.272 | | | | |
| R3 | 0.906 | d3= | 0.984 | nd2 | 1.6610 | v2 | 20.53 |
| R4 | 1.547 | d4= | 0.129 | | | | |
| R5 | −98.426 | d5= | 0.394 | nd3 | 1.5444 | v3 | 55.82 |
| R6 | −1.165 | d6= | 0.052 | | | | |
| R7 | 1.229 | d7= | 0.627 | nd4 | 1.4959 | v4 | 81.64 |
| R8 | −0.775 | d8= | 0.413 | | | | |
| R9 | ∞ | d9= | 0.443 | ndg | 1.5168 | vg | 64.17 |
| R10 | ∞ | d10= | 0.265 | | | | |

Table 4 shows the aspherical surface data of the camera optical lens 20 in the embodiment 2 of the present disclosure.

TABLE 4

| | Conic Index | Aspherical Surface Index | | | | |
|---|---|---|---|---|---|---|
| | k | A4 | A6 | A8 | A10 | A12 |
| R1 | 1.5794E−02 | −1.1260E+00 | 4.7505E+00 | −1.3755E+01 | 2.8408E+01 | −4.2476E+01 |
| R2 | −1.0019E+00 | −1.6901E+00 | −3.7609E+00 | 1.8085E+02 | −1.6379E+03 | 5.9944E+03 |
| R3 | 1.1965E−02 | −3.0452E−02 | −3.2986E+00 | 3.9564E+01 | −1.5718E+02 | −2.0181E+03 |
| R4 | −2.8614E−01 | 3.3812E+00 | −1.9626E+02 | 2.0136E+04 | −1.2835E+06 | 5.6318E+07 |
| R5 | −7.5000E+01 | 1.1229E+00 | −4.8624E+01 | 8.8304E+03 | −1.0804E+06 | 8.8238E+07 |
| R6 | 5.4129E−02 | −3.4715E+00 | 3.3192E+01 | 6.2198E+02 | −3.1033E+04 | 4.9366E+05 |
| R7 | 3.5729E−01 | −3.5198E+00 | 6.0305E+01 | −6.9811E+02 | 5.4912E+03 | −2.9457E+04 |
| R8 | −1.3408E−03 | 7.0464E−01 | 1.6186E+00 | 4.6543E+00 | −3.7288E+01 | 1.6973E+02 |
| | Conic Index | Aspherical Surface Index | | | | |
| | k | A14 | A16 | A18 | A20 | A22 |
| R1 | 1.5794E−02 | 4.6116E+01 | −3.6205E+01 | 2.0292E+01 | −7.9052E+00 | 2.0319E+00 |
| R2 | −1.0019E+00 | 8.7913E+03 | −1.9750E+05 | 9.9365E+05 | −2.8308E+06 | 5.1477E+06 |
| R3 | 1.1965E−02 | 3.5354E+04 | −2.6526E+05 | 1.2133E+06 | −3.6730E+06 | 7.5370E+06 |
| R4 | −2.8614E−01 | −1.7279E+09 | 3.7201E+10 | −5.5142E+11 | 5.3534E+12 | −3.0551E+13 |
| R5 | −7.5000E+01 | −4.5063E+09 | 1.4040E+11 | −2.5554E+12 | 2.4460E+13 | −9.1939E+13 |
| R6 | 5.4129E−02 | −2.8839E+06 | −1.8319E+07 | 4.2846E+08 | −3.0546E+09 | 1.0334E+10 |
| R7 | 3.5729E−01 | 1.0518E+05 | −2.3858E+05 | 3.1074E+05 | −1.7675E+05 | 0.0000E+00 |
| R8 | −1.3408E−03 | −6.9832E+02 | 1.7185E+03 | −2.1222E+03 | 1.0491E+03 | 0.0000E+00 |

| | |
|---|---|
| Conic Index | Aspherical Surface Index |

| | k | A24 | A26 | A28 | A30 |
|---|---|---|---|---|---|
| R1 | 1.5794E−02 | −3.0969E−01 | 2.1191E−02 | 0.0000E+00 | 0.0000E+00 |
| R2 | −1.0019E+00 | −6.1021E+06 | 4.5824E+06 | −1.9858E+06 | 3.7930E+05 |
| R3 | 1.1965E−02 | −1.0408E+07 | 9.2853E+06 | −4.8424E+06 | 1.1224E+06 |
| R4 | −2.8614E−01 | 7.7448E+13 | 0.0000E+00 | 0.0000E+00 | 0.0000E+00 |
| R5 | −7.5000E+01 | 0.0000E+00 | 0.0000E+00 | 0.0000E+00 | 0.0000E+00 |
| R6 | 5.4129E−02 | −1.4002E+10 | 0.0000E+00 | 0.0000E+00 | 0.0000E+00 |
| R7 | 3.5729E−01 | 0.0000E+00 | 0.0000E+00 | 0.0000E+00 | 0.0000E+00 |
| R8 | −1.3408E−03 | 0.0000E+00 | 0.0000E+00 | 0.0000E+00 | 0.0000E+00 |

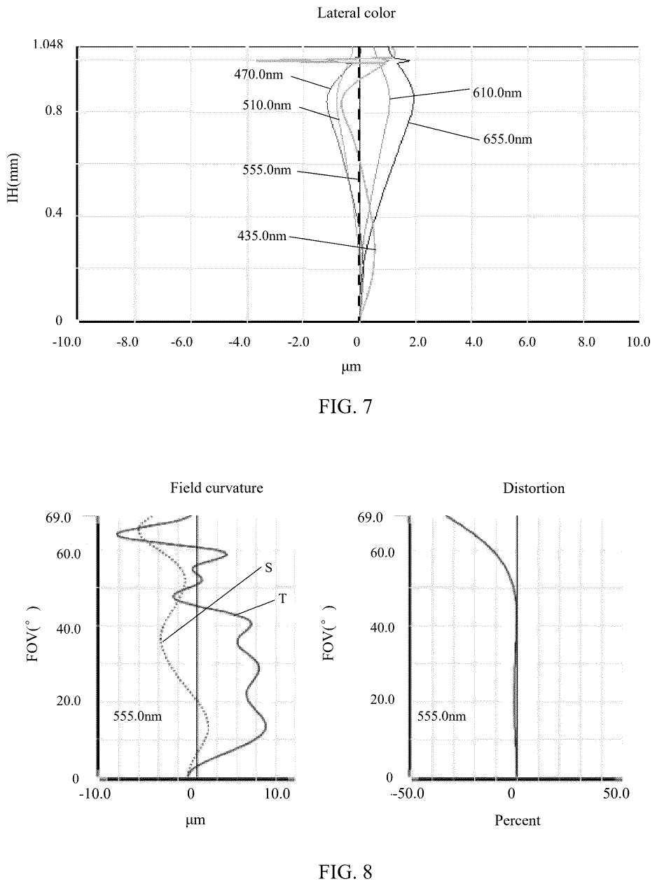

FIG. 6 and FIG. 7 show the longitudinal aberration and lateral color schematic diagrams after light with a wavelength of 655 nm, 610 nm, 555 nm, 510 nm, 470 nm and 435 nm passes the camera optical lens 20 in the second embodiment. FIG. 8 shows the field curvature and distortion schematic diagrams after light with a wavelength of 555 nm passes the camera optical lens 20 in the second embodiment, the field curvature S in FIG. 8 is a field curvature in the sagittal direction, T is a field curvature in the meridian direction.

In this embodiment, the pupil entering diameter of the camera optical lens is 0.197 mm, the image height at the 1.0 field position is 1.048 mm, the vision field angle at the 1.0 field position is 139.49°, and the f-number is 3.04. The camera optical lens 20 satisfies the design requirements of a wide field of view, large depth of field, and high-definition imaging.

### Embodiment 3

Embodiment 3 is basically the same as embodiment 1, the meaning of its symbols is the same as that of embodiment 1, in the following, only the differences are described.

Differing from the first embodiment, the object side surface of the first lens L1 is concave in the paraxial region, and the object side surface of the third lens L3 is convex in the paraxial region.

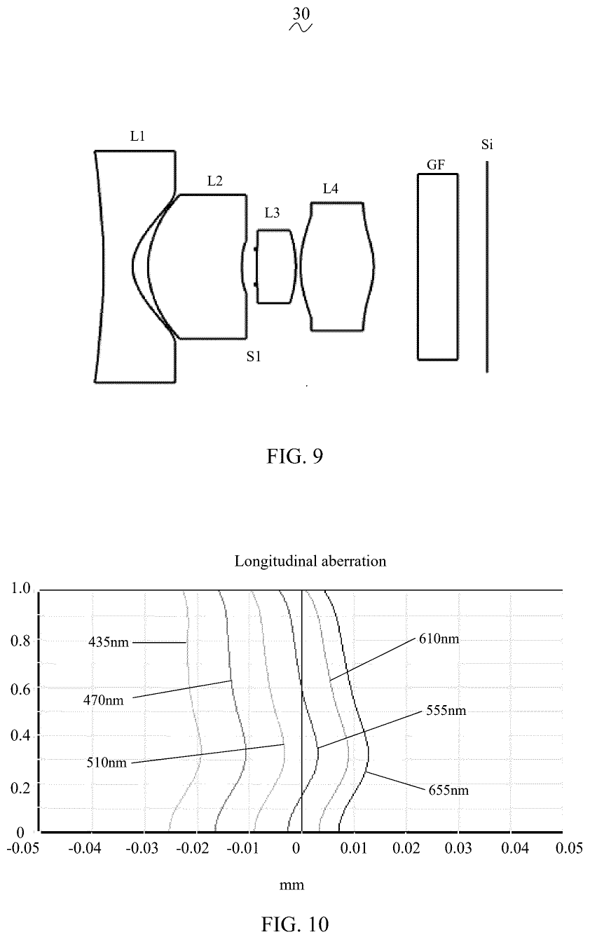

FIG. 9 illustrates a camera optical lens 30 according to a third embodiment of the present disclosure.

Tables 5 and 6 present the design data of the camera optical lens 30 according to the third embodiment of the present disclosure.

TABLE 5

| | R | d | | nd | | vd | |
|---|---|---|---|---|---|---|---|
| S1 | ∞ | d0= | −1.554 | | | | |
| R1 | −81.457 | d1= | 0.300 | nd1 | 1.5444 | v1 | 55.82 |
| R2 | 0.422 | d2= | 0.159 | | | | |
| R3 | 0.917 | d3= | 0.964 | nd2 | 1.6610 | v2 | 20.53 |
| R4 | 2.072 | d4= | 0.151 | | | | |
| R5 | 31.839 | d5= | 0.400 | nd3 | 1.5444 | v3 | 55.82 |
| R6 | −1.616 | d6= | 0.048 | | | | |
| R7 | 1.008 | d7= | 0.751 | nd4 | 1.4959 | v4 | 81.64 |
| R8 | −0.867 | d8= | 0.453 | | | | |
| R9 | ∞ | d9= | 0.410 | ndg | 1.5168 | vg | 64.17 |
| R10 | ∞ | d10= | 0.305 | | | | |

Table 6 shows the aspherical surface data of the camera optical lens 30 in the embodiment 3 of the present disclosure.

TABLE 6

| | Conic Index | Aspherical Surface Index | | | | |
|---|---|---|---|---|---|---|
| | k | A4 | A6 | A8 | A10 | A12 |
| R1 | −7.5000E+01 | −7.8235E−01 | 3.7915E+00 | −1.0330E+01 | 1.8296E+01 | −2.2207E+01 |
| R2 | −1.0062E+00 | −3.3214E−01 | −4.3069E+01 | 8.7943E+02 | −1.1138E+04 | 1.0061E+05 |
| R3 | 4.4553E−02 | 3.2488E−01 | −1.5488E+01 | 2.0632E+02 | −2.1441E+03 | 2.0071E+04 |
| R4 | 5.3451E+01 | 3.2949E+00 | −2.3494E+02 | 2.3463E+04 | −1.5176E+06 | 6.7304E+07 |
| R5 | 7.5000E+01 | 1.4940E+00 | 1.5570E+02 | −2.3731E+04 | 2.0684E+06 | −1.0839E+08 |
| R6 | −1.0677E+01 | −2.9670E+00 | 1.2501E+01 | 2.0317E+03 | −9.0680E+04 | 2.0759E+06 |
| R7 | 2.4981E−01 | −3.0289E+00 | 5.5698E+01 | −7.1527E+02 | 6.1368E+03 | −3.5690E+04 |
| R8 | 1.0317E−01 | 7.3443E−01 | 2.6293E+00 | −1.3902E+01 | 1.0906E+02 | −5.4784E+02 |
| | Conic Index | Aspherical Surface Index | | | | |
| | k | A14 | A16 | A18 | A20 | A22 |
| R1 | −7.5000E+01 | 1.8918E+01 | −1.1412E+01 | 4.8559E+00 | −1.4281E+00 | 2.7696E−01 |
| R2 | −1.0062E+00 | −6.5185E+05 | 3.0085E+06 | −9.8839E+06 | 2.3089E+07 | −3.8022E+07 |
| R3 | 4.4553E−02 | −1.5156E+05 | 8.2937E+05 | −3.1891E+06 | 8.6056E+06 | −1.6256E+07 |
| R4 | 5.3451E+01 | −2.0642E+09 | 4.3480E+10 | −6.1388E+11 | 5.5242E+12 | −2.8509E+13 |
| R5 | 7.5000E+01 | 3.5804E+09 | −7.5171E+10 | 9.7341E+11 | −7.0911E+12 | 2.2237E+13 |
| R6 | −1.0677E+01 | −3.0164E+07 | 2.9272E+08 | −1.8963E+09 | 7.8877E+09 | −1.9072E+10 |
| R7 | 2.4981E−01 | 1.3826E+05 | −3.4092E+05 | 4.8335E+05 | −2.9936E+05 | 0.0000E+00 |
| R8 | 1.0317E−01 | 1.4912E+03 | −2.2831E+03 | 1.8829E+03 | −6.5184E+02 | 0.0000E+00 |

| | |
|---|---|
| Conic Index | Aspherical Surface Index |

| | k | A24 | A26 | A28 | A30 |
|---|---|---|---|---|---|
| R1 | −7.5000E+01 | −3.1945E−02 | 1.6631E−03 | 0.0000E+00 | 0.0000E+00 |
| R2 | −1.0062E+00 | 4.3127E+07 | −3.2070E+07 | 1.4078E+07 | −2.7666E+06 |
| R3 | 4.4553E−02 | 2.1124E+07 | −1.8048E+07 | 9.1516E+06 | −2.0899E+06 |
| R4 | 5.3451E+01 | 6.3894E+13 | 0.0000E+00 | 0.0000E+00 | 0.0000E+00 |
| R5 | 7.5000E+01 | 0.0000E+00 | 0.0000E+00 | 0.0000E+00 | 0.0000E+00 |
| R6 | −1.0677E+01 | 2.0389E+10 | 0.0000E+00 | 0.0000E+00 | 0.0000E+00 |
| R7 | 2.4981E−01 | 0.0000E+00 | 0.0000E+00 | 0.0000E+00 | 0.0000E+00 |
| R8 | 1.0317E−01 | 0.0000E+00 | 0.0000E+00 | 0.0000E+00 | 0.0000E+00 |

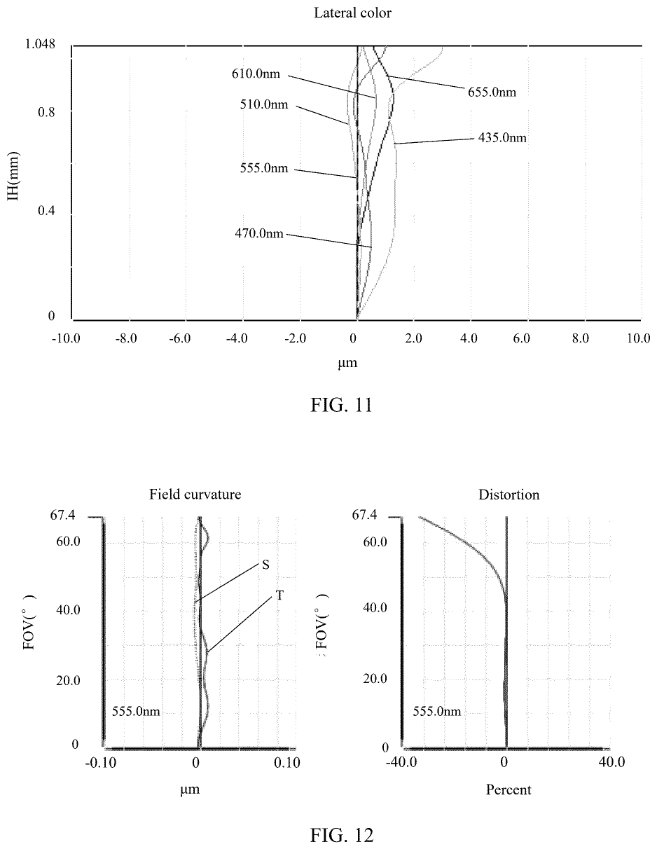

FIG. 10 and FIG. 11 show the longitudinal aberration and lateral color schematic diagrams after light with a wavelength of 655 nm, 610 nm, 555 nm, 510 nm, 470 nm and 435 nm passes the camera optical lens 30 in the third embodiment. FIG. 12 shows the field curvature and distortion schematic diagrams after light with a wavelength of 555 nm passes the camera optical lens 30 in the third embodiment, the field curvature S in FIG. 12 is a field curvature in the sagittal direction, T is a field curvature in the meridian direction.

In this embodiment, the pupil entering diameter of the camera optical lens 30 is 0.219 mm, the image height at the 1.0 field position is 1.048 mm, the vision field angle at the 1.0 field position is 131.99°, and the f-number is 3.03. The camera optical lens 30 satisfies the design requirements of a wide field of view, large depth of field, and high-definition imaging.

### Embodiment 4

Embodiment 4 is basically the same as embodiment 1, the meaning of its symbols is the same as that of embodiment 1, in the following, only the differences are described.

Differing from the first embodiment, the object side surface of the first lens L1 is concave in the paraxial region, and the object side surface of the third lens L3 is convex in the paraxial region.

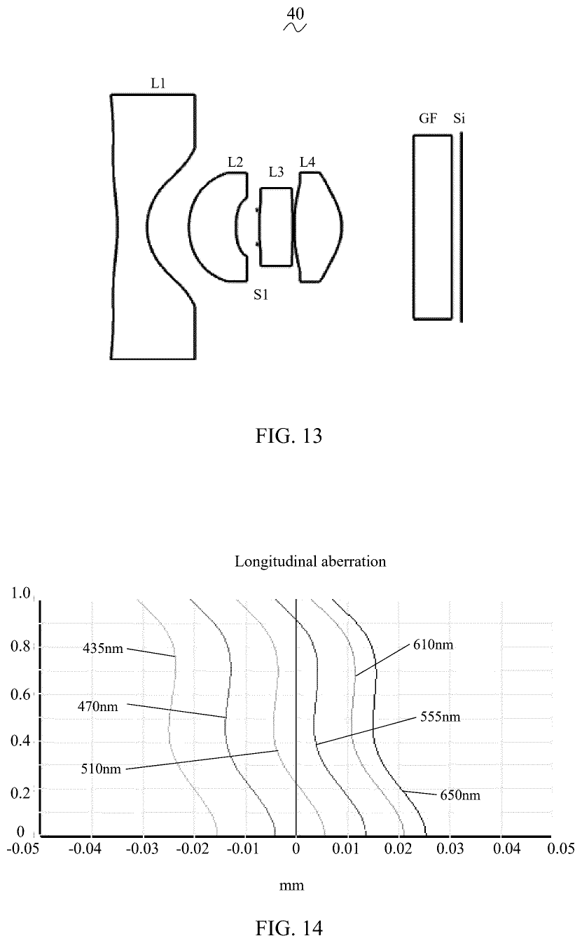

FIG. 13 illustrates a camera optical lens 40 according to a fourth embodiment of the present disclosure.

Tables 7 and 8 present the design data of the camera optical lens 40 according to the fourth embodiment of the present disclosure.

TABLE 7

| | R | d | | nd | | vd | |
|---|---|---|---|---|---|---|---|
| S1 | ∞ | d0= | −1.478 | | | | |
| R1 | −2.310 | d1= | 0.314 | nd1 | 1.5444 | v1 | 55.82 |
| R2 | 0.615 | d2= | 0.444 | | | | |
| R3 | 0.741 | d3= | 0.500 | nd2 | 1.6610 | v2 | 20.53 |
| R4 | 0.979 | d4= | 0.247 | | | | |
| R5 | 3.805 | d5= | 0.354 | nd3 | 1.5444 | v3 | 55.82 |
| R6 | −3.117 | d6= | 0.020 | | | | |
| R7 | 3.325 | d7= | 0.500 | nd4 | 1.4959 | v4 | 81.64 |
| R8 | −0.575 | d8= | 0.759 | | | | |
| R9 | ∞ | d9= | 0.407 | ndg | 1.5168 | vg | 64.17 |
| R10 | ∞ | d10= | 0.103 | | | | |

Table 8 shows the aspherical surface data of the camera optical lens 40 in the embodiment 4 of the present disclosure.

TABLE 8

| | Conic Index | Aspherical Surface Index | | | | |
|---|---|---|---|---|---|---|
| | k | A4 | A6 | A8 | A10 | A12 |
| R1 | −1.2083E+00 | 2.1753E−01 | 9.9890E−01 | −5.1311E+00 | 1.4059E+01 | −2.7508E+01 |
| R2 | −1.3349E+00 | −2.1858E−01 | 1.4591E+00 | 3.0092E+01 | −1.9491E+02 | 4.8933E+02 |
| R3 | 4.5735E−01 | −3.3571E−01 | 1.3696E+01 | −5.3374E+02 | 1.4610E+04 | −2.5369E+05 |
| R4 | 7.9037E+00 | 8.4204E−01 | 7.7906E+01 | −4.5376E+03 | 1.6455E+05 | −3.6011E+06 |
| R5 | 9.6264E+01 | 1.8064E+00 | −1.5818E+02 | 1.6414E+04 | −9.6806E+05 | 3.4766E+07 |
| R6 | −9.9000E+01 | −7.6649E−01 | 5.1906E+01 | 1.1034E+03 | −1.0621E+05 | 3.0210E+06 |
| R7 | −1.3636E+01 | −4.9702E−01 | 5.6434E+01 | 4.2649E+02 | −7.1656E+04 | 2.2182E+06 |
| R8 | −1.3982E+00 | −5.5823E−01 | 4.6946E+01 | −1.9916E+03 | 5.4192E+04 | −9.6450E+05 |
| | Conic Index | Aspherical Surface Index | | | | |
| | k | A14 | A16 | A18 | A20 | A22 |
| R1 | −1.2083E+00 | 4.0035E+01 | −4.3522E+01 | 3.5218E+01 | −2.1026E+01 | 9.1071E+00 |
| R2 | −1.3349E+00 | −6.3785E+02 | 4.3187E+02 | −9.8949E+01 | −5.3573E+01 | 4.3511E+01 |
| R3 | 4.5735E−01 | 2.9496E+06 | −2.3847E+07 | 1.3670E+08 | −5.5852E+08 | 1.6130E+09 |
| R4 | 7.9037E+00 | 4.9759E+07 | −4.3580E+08 | 2.3977E+09 | −8.0201E+09 | 1.4914E+10 |
| R5 | 9.6264E+01 | −7.6962E+08 | 1.0220E+10 | −7.4543E+10 | 2.2932E+11 | 0.0000E+00 |
| R6 | −9.9000E+01 | −4.9719E+07 | 5.3717E+08 | −3.9544E+09 | 1.9839E+10 | −6.5800E+10 |
| R7 | −1.3636E+01 | −4.0196E+07 | 4.9590E+08 | −4.3639E+09 | 2.7721E+10 | −1.2616E+11 |
| R8 | −1.3982E+00 | 1.1800E+07 | −1.0220E+08 | 6.3611E+08 | −2.8540E+09 | 9.1454E+09 |

| | |
|---|---|
| Conic Index | Aspherical Surface Index |

| | k | A24 | A26 | A28 | A30 |
|---|---|---|---|---|---|
| R1 | −1.2083E+00 | −2.7756E+00 | 5.6323E−01 | −6.8197E−02 | 3.7221E−03 |
| R2 | −1.3349E+00 | −1.3245E+01 | 2.6633E+00 | −3.1779E−01 | 1.7029E−02 |
| R3 | 4.5735E−01 | −3.2120E+09 | 4.1892E+09 | −3.2166E+09 | 1.1010E+09 |
| R4 | 7.9037E+00 | −1.1842E+10 | 0.0000E+00 | 0.0000E+00 | 0.0000E+00 |
| R5 | 9.6264E+01 | 0.0000E+00 | 0.0000E+00 | 0.0000E+00 | 0.0000E+00 |
| R6 | −9.9000E+01 | 1.3305E+11 | −1.2872E+11 | −1.3234E+10 | 9.5774E+10 |
| R7 | −1.3636E+01 | 4.0076E+11 | −8.4277E+11 | 1.0529E+12 | −5.9088E+11 |
| R8 | −1.3982E+00 | −2.0404E+10 | 3.0094E+10 | −2.6362E+10 | 1.0382E+10 |

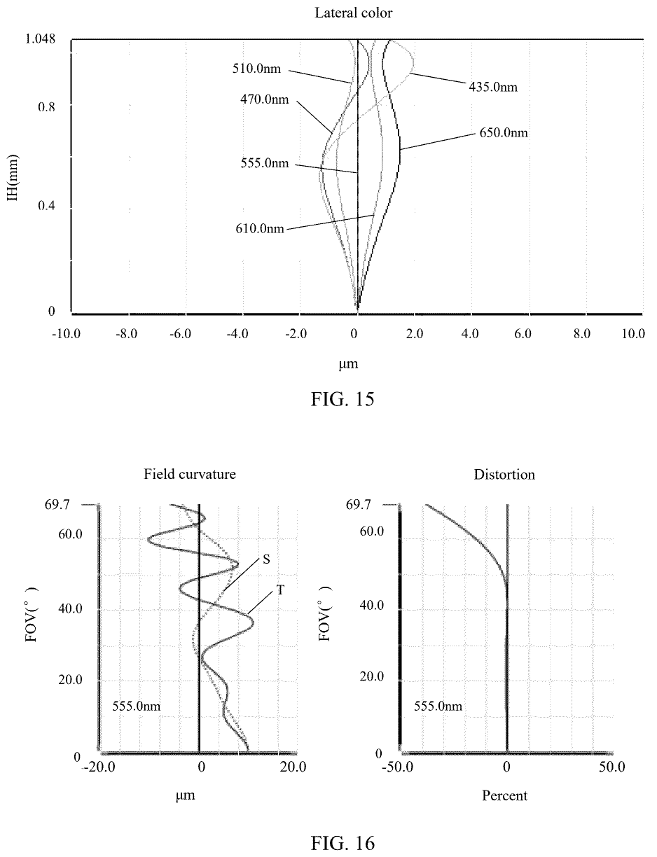

FIG. 14 and FIG. 15 show the longitudinal aberration and lateral color schematic diagrams after light with a wavelength of 655 nm, 610 nm, 555 nm, 510 nm, 470 nm and 435 nm passes the camera optical lens 40 in the fourth embodiment. FIG. 16 shows the field curvature and distortion schematic diagrams after light with a wavelength of 555 nm passes the camera optical lens 40 in the fourth embodiment, the field curvature S in FIG. 16 is a field curvature in the sagittal direction, T is a field curvature in the meridian direction.

In this embodiment, the pupil entering diameter of the camera optical lens 40 is 0.208 mm, the image height at the 1.0 field position is 1.048 mm, the vision field angle at the 1.0 field position is 140.77°, and the f-number is 3.00. The camera optical lens 40 satisfies the design requirements of a wide field of view, large depth of field, and high-definition imaging.

### Embodiment 5

Embodiment 5 is basically the same as embodiment 1, the meaning of its symbols is the same as that of embodiment 1, in the following, only the differences are described.

Differing from the first embodiment, the object side surface of the first lens L1 is concave in the paraxial region, and the object side surface of the third lens L3 is convex in the paraxial region.

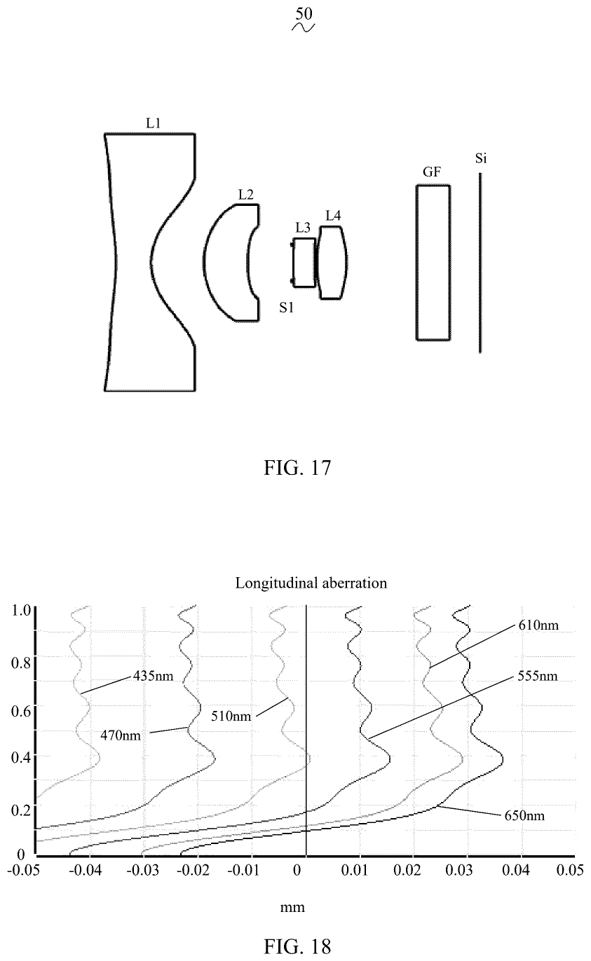

FIG. 17 illustrates a camera optical lens 50 according to a fifth embodiment of the present disclosure.

Tables 9 and 10 present the design data of the camera optical lens 50 according to the fifth embodiment of the present disclosure.

TABLE 9

| | R | d | | nd | | vd | |
|---|---|---|---|---|---|---|---|
| S1 | ∞ | d0= | −2.003 | | | | |
| R1 | −2.845 | d1= | 0.402 | nd1 | 1.5444 | v1 | 55.82 |
| R2 | 0.650 | d2= | 0.602 | | | | |
| R3 | 0.844 | d3= | 0.500 | nd2 | 1.6610 | v2 | 20.53 |
| R4 | 1.680 | d4= | 0.519 | | | | |
| R5 | 3.830 | d5= | 0.248 | nd3 | 1.5444 | v3 | 55.82 |
| R6 | −5.123 | d6= | 0.023 | | | | |
| R7 | 2.897 | d7= | 0.339 | nd4 | 1.4959 | v4 | 81.64 |
| R8 | −0.924 | d8= | 0.801 | | | | |
| R9 | ∞ | d9= | 0.375 | ndg | 1.5168 | vg | 64.17 |
| R10 | ∞ | d10= | 0.344 | | | | |

Table 10 shows the aspherical surface data of the camera optical lens 50 in the embodiment 5 of the present disclosure.

TABLE 10

| | Conic Index | Aspherical Surface Index | | | | |
|---|---|---|---|---|---|---|
| | k | A4 | A6 | A8 | A10 | A12 |
| R1 | 0.0000E+00 | −7.1189E−02 | 1.8110E+00 | −7.4142E+00 | 1.9646E+01 | −3.6961E+01 |
| R2 | −1.0000E+00 | −1.3853E+00 | 1.5041E+01 | −1.3558E+02 | 9.3960E+02 | −4.4899E+03 |
| R3 | 0.0000E+00 | −1.1182E+00 | 3.2512E+01 | −8.2604E+02 | 1.3795E+04 | −1.5287E+05 |
| R4 | 0.0000E+00 | 8.8973E−01 | −2.2175E+01 | 3.9999E+02 | 3.0390E+04 | −1.8997E+06 |
| R5 | 0.0000E+00 | −1.2191E+01 | 8.1717E+03 | −2.5889E+06 | 4.9193E+08 | −6.1025E+10 |
| R6 | 0.0000E+00 | 7.1922E+00 | −5.9403E+02 | 5.7120E+04 | −3.8398E+06 | 1.7910E+08 |
| R7 | 0.0000E+00 | 5.0451E+00 | −4.3124E+01 | −5.6088E+03 | 4.9795E+05 | −2.2244E+07 |
| R8 | 0.0000E+00 | 3.8569E+00 | −3.3675E+02 | 2.0690E+04 | −7.6100E+05 | 1.8284E+07 |
| | Conic Index | Aspherical Surface Index | | | | |
| | k | A14 | A16 | A18 | A20 | A22 |
| R1 | 0.0000E+00 | 5.0186E+01 | −4.9698E+01 | 3.6121E+01 | −1.9246E+01 | 7.4285E+00 |
| R2 | −1.0000E+00 | 1.4788E+04 | −3.4772E+04 | 6.0080E+04 | −7.7258E+04 | 7.3535E+04 |
| R3 | 0.0000E+00 | 1.1709E+06 | −6.3717E+06 | 2.4968E+07 | −7.0587E+07 | 1.4252E+08 |
| R4 | 0.0000E+00 | 5.4376E+07 | −9.7727E+08 | 1.1990E+10 | −1.0339E+11 | 6.2843E+11 |
| R5 | 0.0000E+00 | 5.1950E+12 | −3.1265E+14 | 1.3513E+16 | −4.2096E+17 | 9.3679E+18 |
| R6 | 0.0000E+00 | −6.0028E+09 | 1.4722E+11 | −2.6535E+12 | 3.4951E+13 | −3.3116E+14 |
| R7 | 0.0000E+00 | 6.2174E+08 | −1.1658E+10 | 1.5173E+11 | −1.3907E+12 | 8.9611E+12 |
| R8 | 0.0000E+00 | −3.0175E+08 | 3.5216E+09 | −2.9501E+10 | 1.7791E+11 | −7.6503E+11 |

| | |
|---|---|
| Conic Index | Aspherical Surface Index |

| | k | A24 | A26 | A28 | A30 |
|---|---|---|---|---|---|
| R1 | 0.0000E+00 | −2.0211E+00 | 3.6749E−01 | −4.0073E−02 | 1.9815E−03 |
| R2 | −1.0000E+00 | −5.0445E+04 | 2.3582E+04 | −6.7119E+03 | 8.7558E+02 |
| R3 | 0.0000E+00 | −2.0022E+08 | 1.8571E+08 | −1.0212E+08 | 2.5179E+07 |
| R4 | 0.0000E+00 | −2.6413E+12 | 7.3152E+12 | −1.2018E+13 | 8.8765E+12 |
| R5 | 0.0000E+00 | −1.4522E+20 | 1.4891E+21 | −9.0767E+21 | 2.4891E+22 |
| R6 | 0.0000E+00 | 2.1910E+15 | −9.5864E+15 | 2.4885E+16 | −2.8990E+16 |
| R7 | 0.0000E+00 | −3.9802E+13 | 1.1622E+14 | −2.0112E+14 | 1.5656E+14 |
| R8 | 0.0000E+00 | 2.2866E+12 | −4.5103E+12 | 5.2756E+12 | −2.7701E+12 |

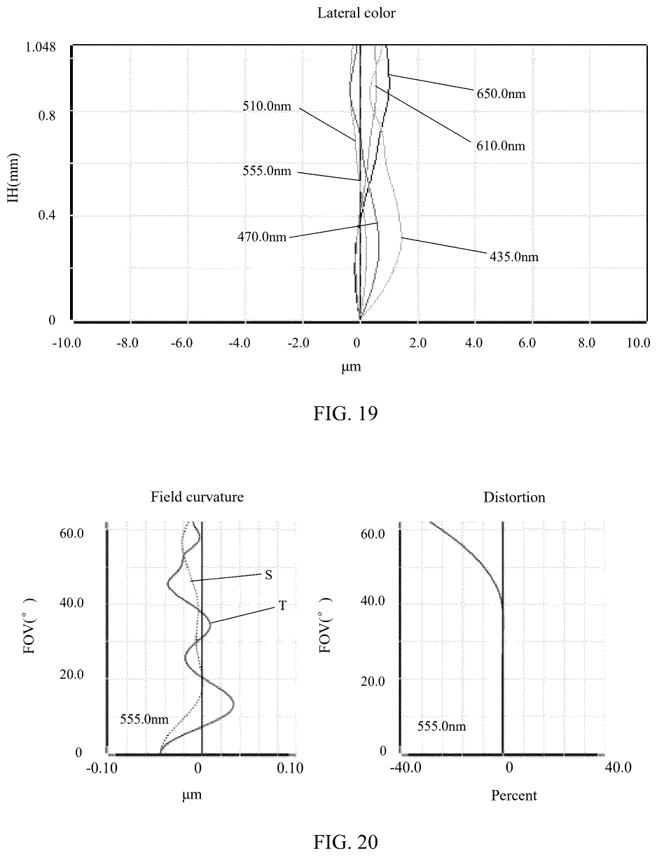

FIG. 18 and FIG. 19 show the longitudinal aberration and lateral color schematic diagrams after light with a wavelength of 655 nm, 610 nm, 555 nm, 510 nm, 470 nm and 435 nm passes the camera optical lens 50 in the fifth embodiment. FIG. 20 shows the field curvature and distortion schematic diagrams after light with a wavelength of 555 nm passes the camera optical lens 50 in the fifth embodiment, the field curvature S in FIG. 20 is a field curvature in the sagittal direction, T is a field curvature in the meridian direction.

In this embodiment, the pupil entering diameter of the camera optical lens 50 is 0.224 mm, the image height at the 1.0 field position is 1.048 mm, the vision field angle at the 1.0 field position is 123.93°, and the f-number is 3.36. The camera optical lens 50 satisfies the design requirements of a wide field of view, large depth of field, and high-definition imaging.

### Embodiment 6

Embodiment 6 is basically the same as embodiment 1, the meaning of its symbols is the same as that of embodiment 1, in the following, only the differences are described.

Differing from the first embodiment, the object side surface of the first lens L1 is concave in the paraxial region, and the object side surface of the third lens L3 is convex in the paraxial region.

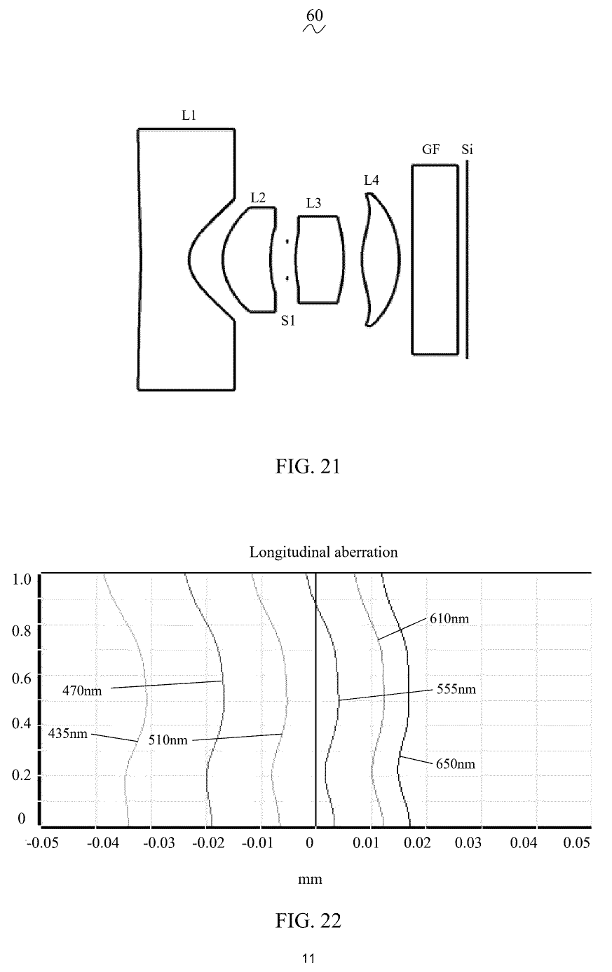

FIG. 21 illustrates a camera optical lens 60 according to a sixth embodiment of the present disclosure.

Tables 11 and 12 present the design data of the camera optical lens 60 according to the sixth embodiment of the present disclosure.

TABLE 11

| | R | d | | nd | | vd | |
|---|---|---|---|---|---|---|---|
| S1 | ∞ | d0= | −1.518 | | | | |
| R1 | −8.211 | d1= | 0.500 | nd1 | 1.5444 | v1 | 0.00 |
| R2 | 0.329 | d2= | 0.349 | | | | |
| R3 | 0.558 | d3= | 0.497 | nd2 | 1.6700 | v2 | 0.00 |
| R4 | 1.803 | d4= | 0.259 | | | | |
| R5 | 1.547 | d5= | 0.499 | nd3 | 1.5444 | v3 | 0.00 |
| R6 | −2.223 | d6= | 0.189 | | | | |
| R7 | 0.795 | d7= | 0.388 | nd4 | 1.4959 | v4 | 81.64 |
| R8 | −1.076 | d8= | 0.136 | | | | |
| R9 | ∞ | d9= | 0.470 | ndg | 1.5168 | vg | 64.17 |
| R10 | ∞ | d10= | 0.097 | | | | |

Table 12 shows the aspherical surface data of the camera optical lens 60 in the embodiment 6 of the present disclosure.

TABLE 12

| | Conic Index | Aspherical Surface Index | | | | |
|---|---|---|---|---|---|---|
| | k | A4 | A6 | A8 | A10 | A12 |
| R1 | 0.0000E+00 | 8.0753E−03 | 3.0504E−01 | −8.1970E−01 | 1.0599E+00 | −1.1337E+00 |
| R2 | −1.0000E+00 | −2.4310E+00 | 4.4286E+01 | −1.0644E+03 | 2.0079E+04 | −2.6459E+05 |
| R3 | −9.9266E−01 | −2.8359E+00 | 1.4614E+02 | −5.1324E+03 | 1.2402E+05 | −2.1086E+06 |
| R4 | 1.7931E+00 | 1.3030E+00 | −2.9193E+02 | 4.1659E+04 | −3.3503E+06 | 1.7283E+08 |
| R5 | −4.5243E−01 | 3.1954E+00 | −8.7184E+02 | 1.2563E+05 | −1.1039E+07 | 6.4619E+08 |
| R6 | 2.1331E−01 | −2.6183E+00 | 1.2765E+02 | −6.3779E+03 | 2.2185E+05 | −5.4077E+06 |
| R7 | 8.6280E−05 | −1.3127E+00 | −4.1703E+01 | 1.3397E+03 | −2.3823E+04 | 2.7617E+05 |
| R8 | 5.2863E−02 | −1.8480E+00 | 1.2511E+02 | −3.8418E+03 | 6.9530E+04 | −8.1755E+05 |
| | Conic Index | Aspherical Surface Index | | | | |
| | k | A14 | A16 | A18 | A20 | A22 |
| R1 | 0.0000E+00 | 2.4991E+00 | −5.8715E+00 | 8.9504E+00 | −8.8118E+00 | 5.7621E+00 |
| R2 | −1.0000E+00 | 2.4211E+06 | −1.5742E+07 | 7.3948E+07 | −2.5220E+08 | 6.1918E+08 |
| R3 | −9.9266E−01 | 2.5736E+07 | −2.2879E+08 | 1.4915E+09 | −7.1160E+09 | 2.4529E+10 |
| R4 | 1.7931E+00 | −6.0834E+09 | 1.5125E+11 | −2.7022E+12 | 3.4832E+13 | −3.2099E+14 |
| R5 | −4.5243E−01 | −2.6433E+10 | 7.7676E+11 | −1.6623E+13 | 2.5958E+14 | −2.9266E+15 |
| R6 | 2.1331E−01 | 9.4709E+07 | −1.2077E+09 | 1.1263E+10 | −7.6552E+10 | 3.7419E+11 |
| R7 | 8.6280E−05 | −2.2175E+06 | 1.2711E+07 | −5.2747E+07 | 1.5872E+08 | −3.4263E+08 |
| R8 | 5.2863E−02 | 6.5906E+06 | −3.7602E+07 | 1.5437E+08 | −4.5782E+08 | 9.7223E+08 |

| | |
|---|---|
| Conic Index | Aspherical Surface Index |

| | k | A24 | A26 | A28 | A30 |
|---|---|---|---|---|---|
| R1 | 0.0000E+00 | −2.5035E+00 | 6.9719E−01 | −1.1293E−01 | 8.1044E−03 |
| R2 | −1.0000E+00 | −1.0671E+09 | 1.2257E+09 | −8.4276E+08 | 2.6239E+08 |
| R3 | −9.9266E−01 | −5.9403E+10 | 9.5795E+10 | −9.2298E+10 | 4.0172E+10 |
| R4 | 1.7931E+00 | 2.0615E+15 | −8.7602E+15 | 2.2125E+16 | −2.5136E+16 |
| R5 | −4.5243E−01 | 2.3198E+16 | −1.2262E+17 | 3.8788E+17 | −5.5531E+17 |
| R6 | 2.1331E−01 | −1.2792E+12 | 2.8998E+12 | −3.9135E+12 | 2.3788E+12 |
| R7 | 8.6280E−05 | 5.1663E+08 | −5.1602E+08 | 3.0641E+08 | −8.1773E+07 |
| R8 | 5.2863E−02 | −1.4415E+09 | 1.4169E+09 | −8.2956E+08 | 2.1896E+08 |

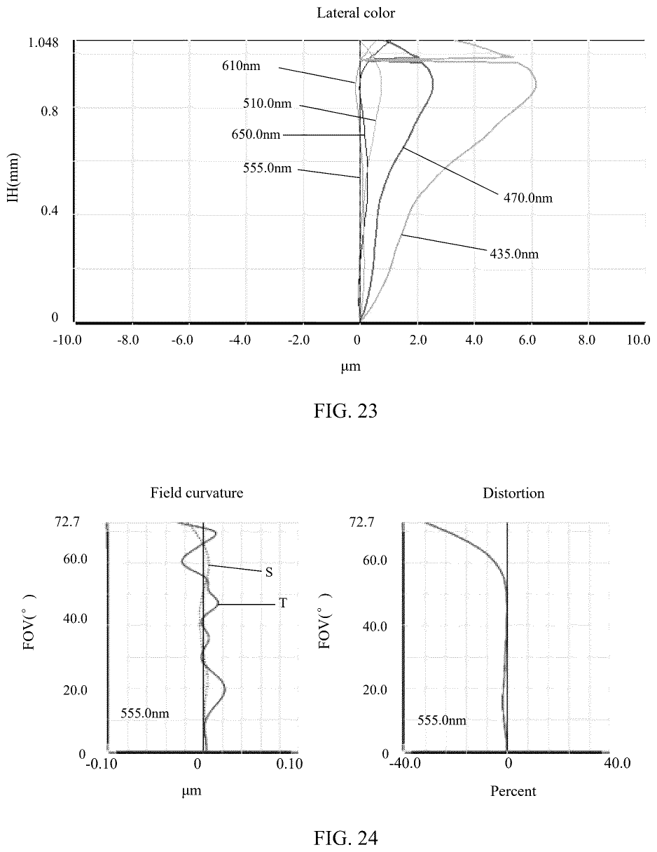

FIG. 22 and FIG. 23 show the longitudinal aberration and lateral color schematic diagrams after light with a wavelength of 655 nm, 610 nm, 555 nm, 510 nm, 470 nm and 435 nm passes the camera optical lens 60 in the sixth embodiment. FIG. 24 shows the field curvature and distortion schematic diagrams after light with a wavelength of 555 nm passes the camera optical lens 60 in the sixth embodiment, the field curvature S in FIG. 24 is a field curvature in the sagittal direction, T is a field curvature in the meridian direction.

In this embodiment, the pupil entering diameter of the camera optical lens 60 is 0.224 mm, the image height at the 1.0 field position is 1.048 mm, the vision field angle at the 1.0 field position is 142.85°, and the f-number is 2.19. The camera optical lens 60 satisfies the design requirements of a wide field of view, large depth of field, and high-definition imaging.

### Embodiment 7

Embodiment 7 is basically the same as embodiment 1, the meaning of its symbols is the same as that of embodiment 1, in the following, only the differences are described.

Differing from the first embodiment, the object side surface of the third lens L3 is convex in the paraxial region.

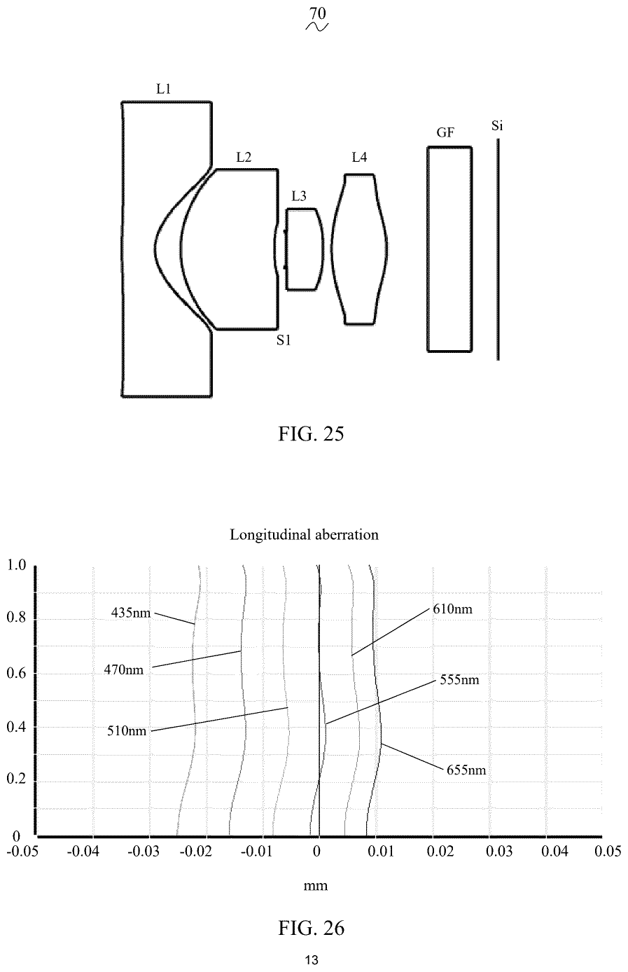

FIG. 25 illustrates a camera optical lens 70 according to a seventh embodiment of the present disclosure.

Tables 13 and 14 present the design data of the camera optical lens 70 according to the seventh embodiment of the present disclosure.

TABLE 13

| | R | d | | nd | | vd | |
|---|---|---|---|---|---|---|---|
| S1 | ∞ | d0= | −1.694 | | | | |
| R1 | 2.790 | d1= | 0.345 | nd1 | 1.5444 | v1 | 55.82 |
| R2 | 0.337 | d2= | 0.268 | | | | |
| R3 | 0.814 | d3= | 0.978 | nd2 | 1.6610 | v2 | 20.53 |
| R4 | 1.571 | d4= | 0.124 | | | | |
| R5 | 47.502 | d5= | 0.382 | nd3 | 1.5444 | v3 | 55.82 |
| R6 | −1.527 | d6= | 0.089 | | | | |
| R7 | 1.005 | d7= | 0.574 | nd4 | 1.4959 | v4 | 81.64 |
| R8 | −0.827 | d8= | 0.428 | | | | |
| R9 | ∞ | d9= | 0.453 | ndg | 1.5168 | vg | 64.17 |
| R10 | ∞ | d10= | 0.279 | | | | |

Table 14 shows the aspherical surface data of the camera optical lens 70 in the embodiment 7 of the present disclosure.

TABLE 14

| | Conic Index | Aspherical Surface Index | | | | |
|---|---|---|---|---|---|---|
| | k | A4 | A6 | A8 | A10 | A12 |
| R1 | 6.4720E−03 | −1.2447E+00 | 5.1749E+00 | −1.4553E+01 | 2.9344E+01 | −4.3455E+01 |
| R2 | −9.9957E−01 | −2.7423E+00 | 5.3760E+00 | 1.5694E+02 | −2.4998E+03 | 2.1103E+04 |
| R3 | −9.6508E−04 | −5.4540E−01 | 4.6354E+00 | −7.0210E+01 | 7.1657E+02 | −4.4516E+03 |
| R4 | −2.2793E+00 | 3.5902E+00 | −2.7899E+02 | 3.4115E+04 | −2.5829E+06 | 1.3206E+08 |
| R5 | −7.5000E+01 | 1.6225E+00 | −1.5500E+02 | 2.3686E+04 | −2.4509E+06 | 1.8012E+08 |
| R6 | 2.6906E−01 | −2.6471E+00 | 4.8165E+00 | 1.3936E+03 | −5.6613E+04 | 1.1783E+06 |
| R7 | −1.2710E+01 | −9.1401E−01 | 2.3057E+01 | −2.4156E+02 | 1.6177E+03 | −7.2794E+03 |
| R8 | −4.4030E+00 | −2.3767E−01 | 3.4526E+00 | −5.7741E+00 | 3.4179E+01 | −2.5369E+02 |
| | Conic Index | Aspherical Surface Index | | | | |
| | k | A14 | A16 | A18 | A20 | A22 |
| R1 | 6.4720E−03 | 4.7436E+01 | −3.7896E+01 | 2.1793E+01 | −8.7570E+00 | 2.3290E+00 |
| R2 | −9.9957E−01 | −1.1631E+05 | 4.3358E+05 | −1.1035E+06 | 1.9114E+06 | −2.2029E+06 |
| R3 | −9.6508E−04 | 1.6416E+04 | −3.4571E+04 | 3.2858E+04 | 1.6181E+04 | −7.7107E+04 |
| R4 | −2.2793E+00 | −4.6334E+09 | 1.1157E+11 | −1.8066E+12 | 1.8730E+13 | −1.1182E+14 |
| R5 | −7.5000E+01 | −8.9875E+09 | 2.9147E+11 | −5.8177E+12 | 6.4480E+13 | −3.0208E+14 |
| R6 | 2.6906E−01 | −1.5071E+07 | 1.2238E+08 | −6.1470E+08 | 1.7415E+09 | −2.1265E+09 |
| R7 | −1.2710E+01 | 2.1697E+04 | −4.0991E+04 | 4.4362E+04 | −2.0883E+04 | 0.0000E+00 |
| R8 | −4.4030E+00 | 8.1122E+02 | −1.3174E+03 | 1.0833E+03 | −3.5328E+02 | 0.0000E+00 |

| | |
|---|---|
| Conic Index | Aspherical Surface Index |

| | k | A24 | A26 | A28 | A30 |
|---|---|---|---|---|---|
| R1 | 6.4720E−03 | −3.6796E−01 | 2.6125E−02 | 0.0000E+00 | 0.0000E+00 |
| R2 | −9.9957E−01 | 1.5919E+06 | −6.1732E+05 | 6.2028E+04 | 2.2546E+04 |
| R3 | −9.6508E−04 | 7.7157E+04 | −2.7558E+04 | 0.0000E+00 | 0.0000E+00 |
| R4 | −2.2793E+00 | 2.9092E+14 | 0.0000E+00 | 0.0000E+00 | 0.0000E+00 |
| R5 | −7.5000E+01 | 0.0000E+00 | 0.0000E+00 | 0.0000E+00 | 0.0000E+00 |
| R6 | 2.6906E−01 | 0.0000E+00 | 0.0000E+00 | 0.0000E+00 | 0.0000E+00 |
| R7 | −1.2710E+01 | 0.0000E+00 | 0.0000E+00 | 0.0000E+00 | 0.0000E+00 |
| R8 | −4.4030E+00 | 0.0000E+00 | 0.0000E+00 | 0.0000E+00 | 0.0000E+00 |

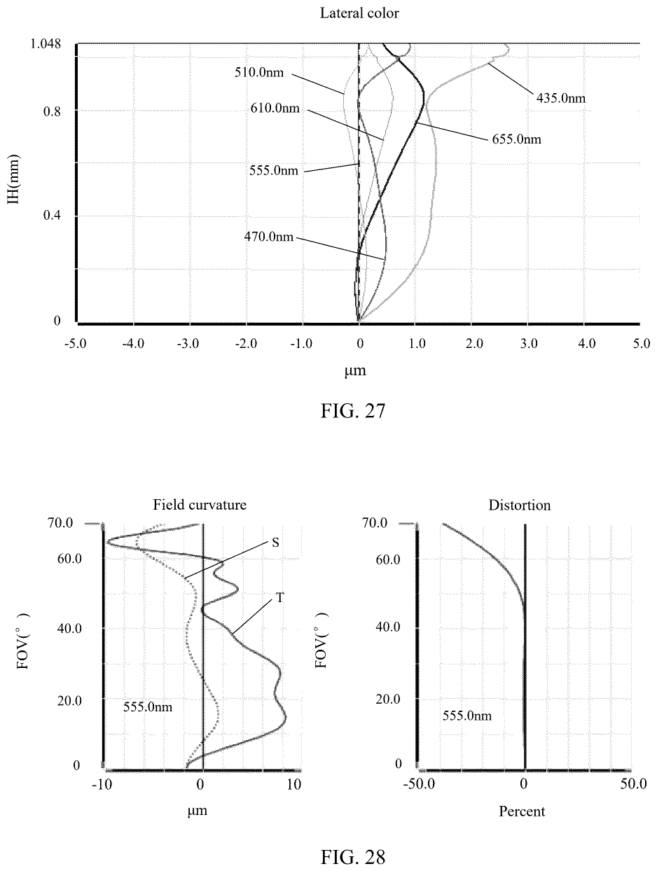

FIG. 26 and FIG. 27 show the longitudinal aberration and lateral color schematic diagrams after light with a wavelength of 655 nm, 610 nm, 555 nm, 510 nm, 470 nm and 435 nm passes the camera optical lens 70 in the seventh embodiment. FIG. 28 shows the field curvature and distortion schematic diagrams after light with a wavelength of 555 nm passes the camera optical lens 70 in the seventh embodiment, the field curvature S in FIG. 28 is a field curvature in the sagittal direction, T is a field curvature in the meridian direction.

In this embodiment, the pupil entering diameter of the camera optical lens 70 is 0.204 mm, the image height at the 1.0 field position is 1.048 mm, the vision field angle at the 1.0 field position is 140.06°, and the f-number is 3.03. The camera optical lens 70 satisfies the design requirements of a wide field of view, large depth of field, and high-definition imaging.

Table 15 lists the values corresponding to the parameters specified in the conditional expressions for each of the first to seventh embodiments.

TABLE 15

| Parameters and | | | | | | | |
|---|---|---|---|---|---|---|---|
| Conditional | Embodiment | Embodiment | Embodiment | Embodiment | Embodiment | Embodiment | Embodiment |
| Expressions | 1 | 2 | 3 | 4 | 5 | 6 | 7 |
| f1/f | −1.33 | −1.32 | −1.16 | −1.37 | −1.24 | −1.16 | −1.19 |
| FOV/Fno | 46.09 | 45.95 | 43.53 | 47.00 | 36.87 | 65.17 | 46.16 |
| ET1/d1 | 2.85 | 2.67 | 2.76 | 2.84 | 2.56 | 2.00 | 2.71 |
| f3/f4 | 2.66 | 2.02 | 2.62 | 3.10 | 2.79 | 1.77 | 2.67 |
| (R3 + R4)/f2 | 1.26 | 1.21 | 1.62 | 0.69 | 1.23 | 2.29 | 1.43 |
| TTL/f | 6.53 | 6.56 | 5.94 | 5.86 | 5.52 | 6.89 | 6.33 |
| ET1 | 0.895 | 0.925 | 0.827 | 0.891 | 1.029 | 1.001 | 0.934 |
| f | 0.597 | 0.598 | 0.664 | 0.623 | 0.753 | 0.491 | 0.619 |
| f1 | −0.791 | −0.79 | −0.768 | −0.856 | −0.931 | −0.568 | −0.737 |
| f2 | 2.011 | 2.031 | 1.851 | 2.483 | 2.054 | 1.029 | 1.671 |
| f3 | 2.677 | 2.156 | 2.828 | 3.195 | 4.052 | 1.752 | 2.716 |
| f4 | 1.008 | 1.067 | 1.081 | 1.03 | 1.452 | 0.988 | 1.019 |
| Fno | 3.03 | 3.04 | 3.03 | 3.00 | 3.36 | 2.19 | 3.03 |
| TTL | 3.899 | 3.925 | 3.941 | 3.648 | 4.153 | 3.384 | 3.920 |
| IH | 1.068 | 1.068 | 1.068 | 1.068 | 1.068 | 1.068 | 1.068 |
| FOV | 145.66° | 145.38° | 136.32° | 145.73° | 127.85° | 145.34° | 146.39° |

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms where the appended claims are expressed.

What is claimed is:

1. A camera optical lens comprising four lenses which are, in an order from an object side to an image side in sequence: a first lens with a negative refractive power, a second lens with a positive refractive power, a third lens with a positive refractive power, a fourth lens with a positive refractive power; wherein the camera optical lens further satisfies the following conditions:
−1.40≤f1/f≤−1.15;
35.00≤FOV/Fno≤66.00;
2.00≤ET1/d1≤2.90;
1.70≤f3/f4≤3.20;
0.60≤(R3+R4)/f2≤2.40;
where
f: the focal length of the camera optical lens;
f1: the focal length of the first lens;
f2: the focal length of the second lens;
f3: the focal length of the third lens;
f4: the focal length of the fourth lens;
FOV: the field angle of field 1.0 of the camera optical lens;
Fno: the f-number of the camera optical lens;
ET1: the edge thickness of the optical clear aperture of the first lens;
d1: the thickness on-axis of the first lens;
R3: the central curvature radius of the object side surface of the second lens;
R4: the central curvature radius of the image side surface of the second lens.

2. The camera optical lens as described in claim 1 further satisfies the following condition:
5.50≤TTL/f≤7.00; where
TTL: the total optical length of the camera optical lens.

3. The camera optical lens as described in claim 1, wherein at least one of the first lens, the second lens, the third lens, and the fourth lens is made of glass material.

4. The camera optical lens as described in claim 1 further satisfies the following condition:
Dmax≤2.00%; where
Dmax: the maximum absolute value of distortion within the 0.7 field of the camera optical lens.

5. The camera optical lens as described in claim 1, wherein an image side surface of the first lens is concave in the paraxial region, the camera optical lens further satisfies the following conditions:
0.57≤(R1+R2)/(R1−R2)≤1.30;
0.08≤d1/TTL≤0.15; where
TTL: the total optical length of the camera optical lens;
R1: the central curvature radius of object side surface of the first lens;
R2: the central curvature radius of image side surface of the first lens.

6. The camera optical lens as described in claim 1, wherein an object side surface of the second lens is convex in the paraxial region, an image side surface of the second lens is concave in the paraxial region, the camera optical lens further satisfies the following conditions:
2.09≤f2/f≤3.99;
−7.23≤(R3+R4)/(R3−R4)≤−1.89;
0.14≤d3/TTL≤0.3; where
TTL: the total optical length of the camera optical lens;
d3: the thickness on-axis of the second lens.

7. The camera optical lens as described in claim 1, wherein an image side surface of the third lens is convex in the paraxial region, the camera optical lens further satisfies the following conditions:
3.56≤f3/f≤5.39;
−0.18≤(R5+R6)/(R5−R6)≤1.04;
0.07≤d5/TTL≤0.15; where
TTL: the total optical length of the camera optical lens;
R5: the central curvature radius of object side surface of the third lens;
R6: the central curvature radius of image side surface of the third lens;
d5: the thickness on-axis of the third lens.

8. The camera optical lens as described in claim 1, wherein an object side surface of the fourth lens is convex in the paraxial region, an image side surface of the fourth lens is convex in the paraxial region, the camera optical lens further satisfies the following conditions:
1.62≤f4/f≤2.02;
−0.16≤(R7+R8)/(R7−R8)≤0.71;
0.10≤d7/TTL≤0.23; where
TTL: the total optical length of the camera optical lens;
R7: the central curvature radius of object side surface of the fourth lens;
R8: the central curvature radius of image side surface of the fourth lens;
d7: the thickness on-axis of the fourth lens.

9. The camera optical lens as described in claim 1 further satisfies the following condition:
2.19≤Fno≤3.37.

10. The camera optical lens as described in claim 1 further satisfies the following condition:
0.38≤TTL≤4.16; where
TTL: the total optical length of the camera optical lens.
